(19) United States
(12) Patent Application Publication
(10) Pub. No.: US 2014/0298333 A1
(43) Pub. Date: Oct. 2, 2014

(54) Migration processing program, migration method, and cloud computing system

(71) Applicant: FUJITSU LIMITED, Kawasaki-shi (JP)

(72) Inventors: Yusuke Yoshida, Yokohama (JP); Tetsuya Okano, Setagaya (JP); KENICHIROU SHIMOGAWA, numazu (JP)

(73) Assignee: FUJITSU LIMITED, Kawasaki-shi (JP)

(21) Appl. No.: 14/222,707

(22) Filed: Mar. 24, 2014

(30) Foreign Application Priority Data
Mar. 28, 2013 (JP) 2013-068904

(51) Int. Cl. G06F 3/06; G06F 9/455

(52) U.S. Cl. CPC G06F 3/0664; G06F 9/455; G06F 3/0604; G06F 3/0671
USPC 718/1

(57) ABSTRACT

A migration processing including: transferring memory data stored in a memory of a source virtual machine generated on a source physical server from a memory of the source physical server to a memory of a destination physical server; measuring, with respect to each unit area of the memory, an update frequency at which data in the memory of the source physical server are updated by the source virtual machine; re-transferring, from the memory of the source physical server to the memory of the destination physical server, the memory data that are updated by the source virtual machine during the transferring the memory data such that data in a unit area with a first update frequency are preferentially re-transferred over data in a unit area with a second update frequency higher than the first update frequency; and suspending the source virtual machine and then resuming a destination virtual machine.

### CROSS-REFERENCE TO RELATED APPLICATION

This application is based upon and claims the benefit of priority of the prior Japanese Patent Application No. 2013-068904, filed on Mar. 28, 2013, the entire contents of which are incorporated herein by reference.

### FIELD

The present invention relates to a migration processing program, a migration method, and a cloud computing system.

### BACKGROUND

A cloud computing service virtualizes a group of hardware such as a plurality of servers of a server facility on the basis of the service agreement with a user and then provides the user with the infrastructure itself of the virtual machines and networks as a service to be provided through a network.

This type of cloud computing service allows virtualization software (hypervisor) to allocate physical servers (or physical machines) to the plurality of virtual machines to enable service provision through an application program installed in each of the virtual machines. Thus, the plurality of virtual machines are allocated respectively to the plurality of physical servers deployed in the server facility.

Migration, particular live migration, is the technology of moving a virtual machine from a physical server to another physical server without disconnecting the service by an application. Live migration is a vital function in a cloud computing service. For instance, in a case where the number of accesses to a web system by virtual machines on a certain physical server becomes more than expected, and consequently the utilization of the CPU of the physical server by the virtual machines reaches 100% due to the high load of the virtual machines, the virtual machines or other virtual machines need to be moved to another physical server with more capacity. Live migration is taken advantage of in such a case in order to distribute the load of the plurality of virtual machines. Furthermore, in a case where a physical server needs to be restarted, live migration is utilized in order to move the virtual machines on this physical server to another physical server.

Live migration is one of the functions provided in virtualization software. In response to an instruction on live migration from a management server, the virtualization software secures a memory space in a destination physical machine and copies the memory contents to be moved of a source virtual machine to the memory of the destination physical machine via a network. This consequently synchronizes the memory contents of the source virtual machine with the memory content of the destination virtual machine. Then the virtualization software suspends the source virtual machine, resumes the destination virtual machine, and transfers the data on the hard disk to the destination virtual machine. Finally, the memory contents of the source virtual machine are deleted from a source physical machine, completing the process.

Examples of the migration are disclosed in Japanese Patent Application Publication No. 2008-225546, Japanese Patent Application Publication No. 2009-146161, Japanese Patent Application Publication No. 2010-198204, and the document stored in a web site of <http://www.atmarkit.co.jp/fwin2k/operation/livemig01/livemig01_{—}01.html>

### SUMMARY

Most of the time required for live migration is also required for copying memory contents. Because memory contents are copied without suspending the source virtual machine, the source virtual machine newly writes data into the memory during this copy process, and this newly updated contents are further copied. This copy process is repeated until the volume of the updated data reaches substantially zero. For this reason, reducing the amount of time required for copying memory contents effectively helps reduce the time required for live migration.

In the past, it only took a short period of time to copy memory contents due to a low memory capacity supported by the OS, sufficient network bandwidth in a server facility, and low load of an application program on a virtual machine.

In recent years, however, some OS's support memory capacities exceeding a terabyte, and the technology of online databases that can expand databases on a memory has appeared. Furthermore, the enlarged server facility had resulted in narrowing the network bandwidths, and the increased load of applications causes more frequent updates of data during copying. These facts are likely to increase the amount of time required for copying memory contents, and hence the amount of time required for live migration.

One aspect of the embodiment is a non-transitory computer readable medium that stores therein a migration processing program for causing a computer to execute a process comprising:

transferring memory data stored in a memory of a source virtual machine generated on a source physical server from a memory of the source physical server to a memory of a destination physical server;

measuring, with respect to each unit area of the memory, an update frequency at which data in the memory of the source physical server are updated by the source virtual machine;

re-transferring, from the memory of the source physical server to the memory of the destination physical server, the memory data that are updated by the source virtual machine during the transferring the memory data such that data in a unit area with a first update frequency are preferentially re-transferred over data in a unit area with a second update frequency higher than the first update frequency; and

suspending the source virtual machine and then resuming a destination virtual machine on the destination physical server.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating the entire configuration of a cloud computing system according to the present embodiment.

FIG. 2 is a diagram illustrating an example of functions provided in the virtualization software.

FIG. 3 is a diagram illustrating an example of the configuration of the management server.

FIG. 4 is a flowchart illustrating the migration process executed by the virtualization software 4.

FIGS. 5 to 8 are diagrams for explaining the migration process.

FIG. 9 is a flowchart schematically illustrating the memory content transfer process S3.

FIGS. 10, 11 and 12 are diagrams for explaining the memory content transfer process.

FIG. 13 is a flowchart schematically illustrating a memory content transfer process according to a first embodiment.

FIG. 14 is a diagram schematically illustrating the memory content transfer process according to the first embodiment.

FIG. 15 is a flowchart specifically illustrating the memory content transfer process according to the first embodiment.

FIG. 16 is a diagram illustrating an example of the update table.

FIG. 17 is a flowchart illustrating how the update information (the update flags and the number of updates) are recorded in the update table in step S20.

FIG. 18 is a diagram illustrating a table update process S204.

FIG. 19 is a diagram illustrating the process S28 for resetting the transferred page areas in the update table.

FIGS. 20 and 21 are diagrams each illustrating a first specific example of the memory content transfer process.

FIGS. 22 and 23 are flowcharts illustrating the memory content transfer example 2.

FIG. 24 is a flowchart schematically illustrating a memory content transfer process according to a second embodiment.

FIGS. 25 and 26 are flowcharts illustrating a memory content transfer example 3 according to the second embodiment.

FIG. 27 is a diagram illustrating hardware configurations of the cloud computing service portal site, the management server, and the group of hardware in the server facility.

### DESCRIPTION OF EMBODIMENTS

### Configuration of Cloud Computing System

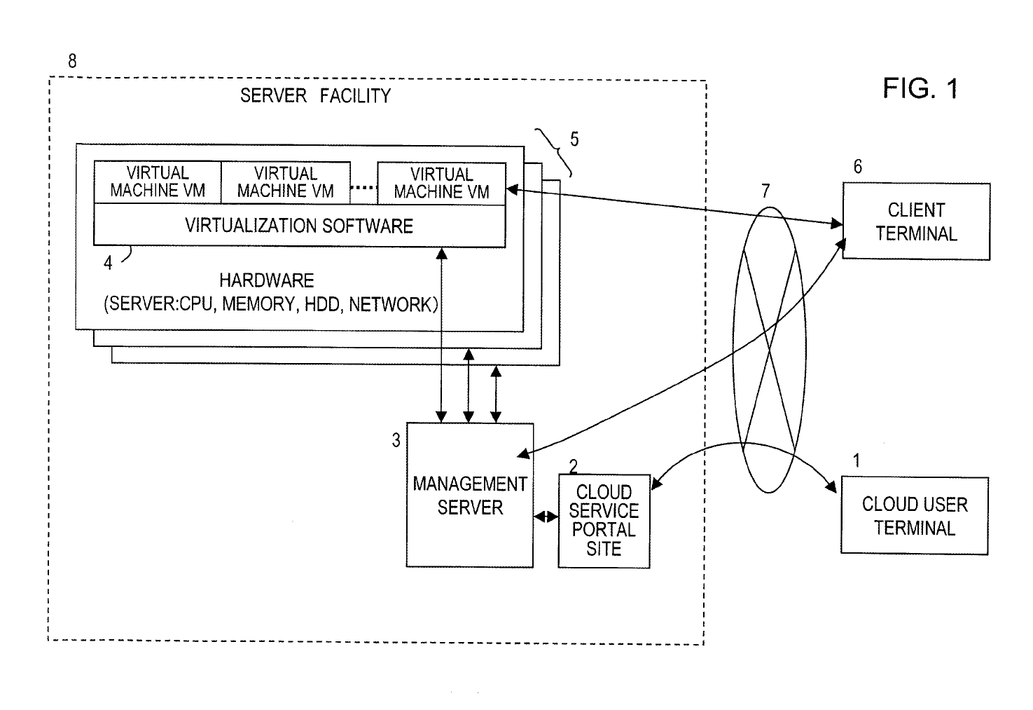

FIG. 1 is a diagram illustrating the entire configuration of a cloud computing system according to the present embodiment. A server facility 8 is provided a group of hardware 5, a cloud computing service portal site 2, and a management server 3. A cloud user terminal 1 and a client terminal receiving a service operated by a cloud user can be connected to the server facility 8 by a network 7 such as the Internet or an intranet.

The group of hardware 5 has a plurality of physical servers (or physical machines), each of which has a CPU, a memory (DRAM), a large-capacity memory such as a hard disk (HDD), and a network. Resources of the group of hardware 5 are allocated to a plurality of virtual machines VM. The cloud computing service portal site 2 and the management server 3 may be constructed by, for example, these virtual machines VM.

A cloud computing service provided to a cloud user by the cloud computing system is a service where the foundation itself for constructing and operating a computer system, i.e., an infrastructure itself for the virtual machines and the network, is provided via the network 7.

The cloud user accesses the cloud computing service portal site 2 from the terminal 1, selects specifications required for the virtual machines, such as a clock frequency of the CPU, memory capacity (GB), capacity of the hard disk (MB/sec, IOPS), and network bandwidth (Gbps), and signs a cloud computing service contract involving these selected specifications. The cloud user terminal 1 also accesses the cloud computing service portal site 2 to monitor the operating states of the virtual machines or control the operations of the virtual machines.

The management server 3 collaborates with a virtualization software (hypervisor) 4 to manage each of the physical servers contained in the group of hardware 5 and allocates the hardware to the virtual machines VM to construct and manage the virtual machines VM.

The virtualization software 4 is infrastructure software that allocates the CPUs, memories, hard disks and networks of the physical servers of the group of hardware 5 to operate the virtual machines in response to an instruction from the management server 3. The virtualization software 4 operates on, for example, the servers contained in the group of hardware 5.

The virtual machines VM not only are allocated the hardware described above but also have in the hard disk image files having an OS, middleware MW, application AP, and database DB. For example, each of the virtual machines VM writes the image files from the hard disk into the memory upon activation to execute an operation corresponding to a desired service.

The client terminal 6 is a terminal of a client who receives a service operated by the cloud user. The client terminal 6 normally accesses the virtual machines VM of the cloud user via the network 7 to receive the service operated by the cloud user.

An operator of the server facility monitors the load status of each of the physical servers by means of the management server 3, and sends an instruction on migration to the virtualization software 4 in order to transfer a virtual machine VM on an overloaded physical server to another physical server. Further, when transferring a virtual machine VM to another physical server for a different reason, the operator sends the instruction on migration to the virtualization software 4. In response to the instruction on migration, the virtualization software 4 executes a migration process on the virtual machine VM to be transferred.

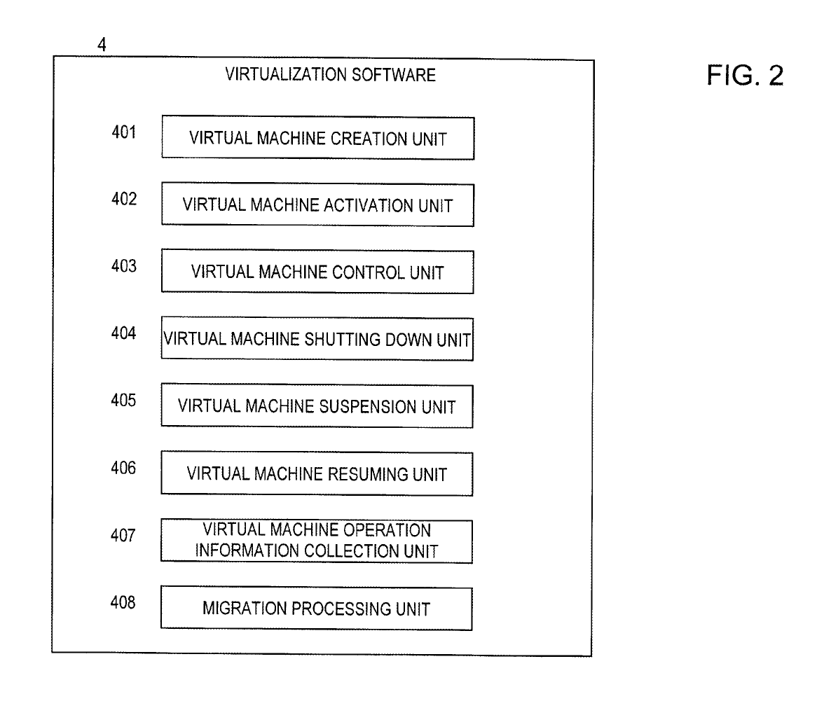

FIG. 2 is a diagram illustrating an example of functions provided in the virtualization software. The virtualization software 4 allocates the resources of the group of hardware 5 to the virtual machines VM to operate the virtual machines VM. The physical machines has, by executing the virtualization software 4, is provided with, for example, a virtual machine creation unit 401 that creates a virtual machine, a virtual machine activation unit 402 that activates the virtual machine, a virtual machine shutting down unit 403 that shuts down the virtual machine, a virtual machine suspension unit 404 that temporarily stops, or suspends, the activated virtual machine, the virtual machine resuming unit 405 that restarts, or resumes, the suspended virtual machine, and a virtual machine operation information collection unit 406 that collects operation information on the virtual machine. The virtualization software 4 also has a migration processing unit 408 that carries out a migration process for transferring a virtual machine from a physical server to another in response to a migration instruction from the management server 3.

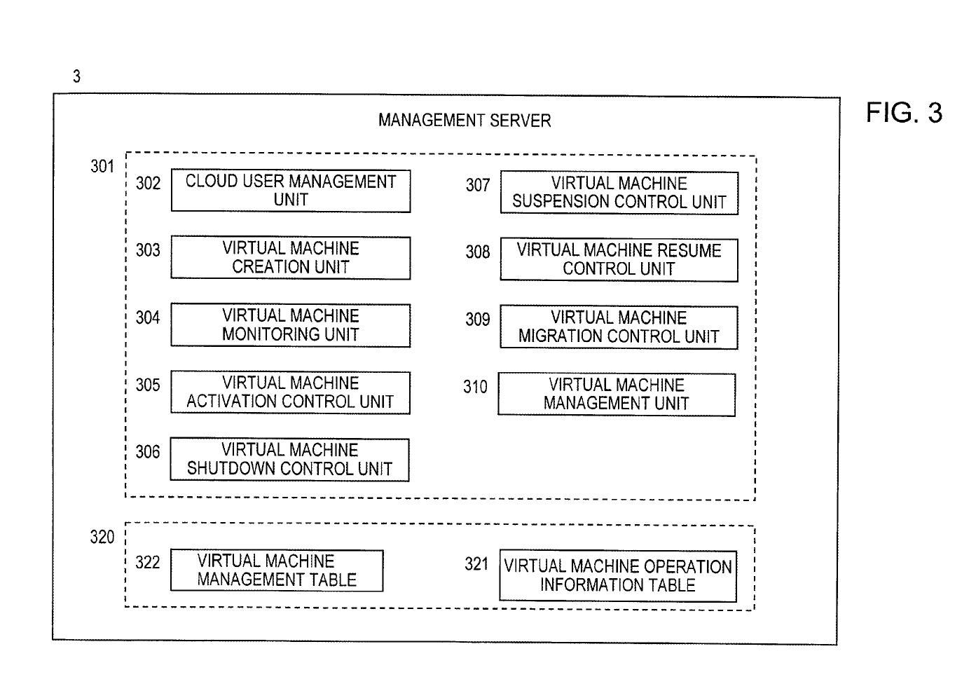

FIG. 3 is a diagram illustrating an example of the configuration of the management server. The management server 3 has software 301 and a storage unit 320 in addition to a CPU and other hardware, which are not illustrated.

The management server has, by executing the software 301, for example, a cloud user management unit 302 for cloud user management such as charging a cloud user who signed a cloud contract in the cloud computing service portal site 2, a virtual machine creation unit 303 that allocates the hardware resources based on the cloud contract to create the virtual machines VM, a virtual machine management unit 310 for managing the virtual machines, and a virtual machine monitoring unit 304 for monitoring the operations of the virtual machines.

The software 301 further has a virtual machine activation control unit 305 for instructing the virtualization software 4 to activate the virtual machines, a virtual machine shutdown control unit 306 for instructing the virtualization software 4 to shut down the activated virtual machines, a virtual machine suspension control unit 307 for instructing the virtualization software 4 to suspend the activated virtual machines, a virtual machine resume control unit 308 for instructing the virtualization software 4 to resume the suspended virtual machines, and a virtual machine migration control unit 309 for instructing the virtualization software 4 to migrate the virtual machines.

The storage unit 320 of the management server has, for example, the virtual machine operation information table 321 that includes the operation information of the virtual machines reported by the virtualization software 4, and a virtual machine management table 322 for managing the virtual machines, the cloud user, and the contract signed by the cloud user.

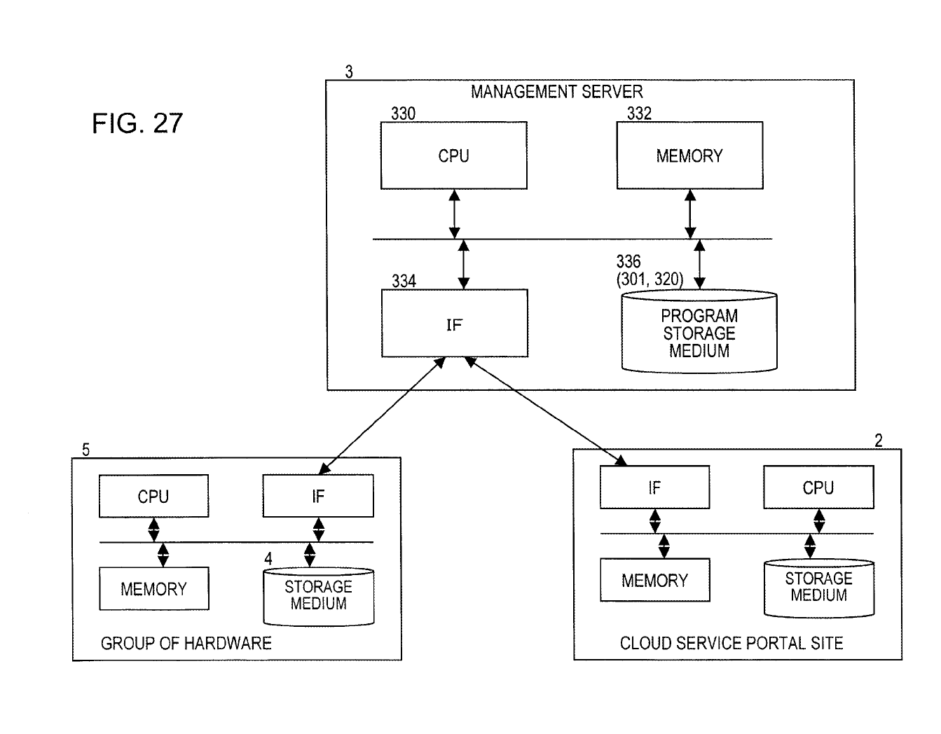

FIG. 27 is a diagram illustrating hardware configurations of the cloud computing service portal site, the management server, and the group of hardware in the server facility. The management server 3 has a CPU 330 functioning as a processor, a memory 332, an external interface 334, and a storage medium 336 for storing the software 301 and tables 321, 322 of the management illustrated in FIG. 3. These components of the management server 3 are connected to one another by a bus.

As with the management server 3, the cloud computing service portal site 2 has a CPU functioning as a processor, a memory, an external interface IF, and a storage medium for storing site control software and the like, and has these components connected to one another by a bus. Furthermore, the group of hardware 5 is a group of computers, each of which has, as with the management server 3, a CPU functioning as a processor, a memory, an external interface IF, and a storage medium for storing software and the like. The virtualization software 4 illustrated in FIG. 2 and the like are stored in each of the storage media of the group of hardware 5.

[Migration]

A migration process executed by the virtualization software 4 is described next. Here is described in particular a live migration process where a source virtual machine that is being operated on a source physical machine is moved to a destination physical machine without stopping the operation of the source virtual machine.

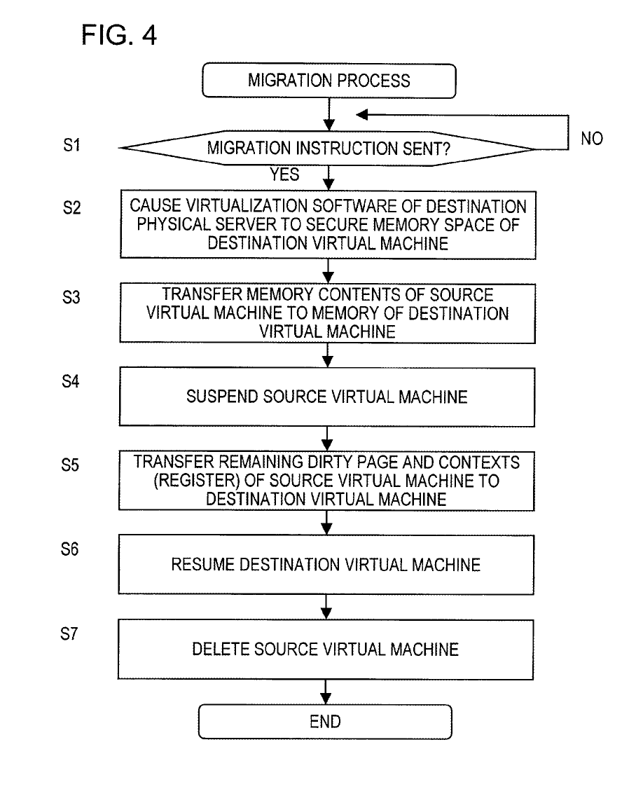

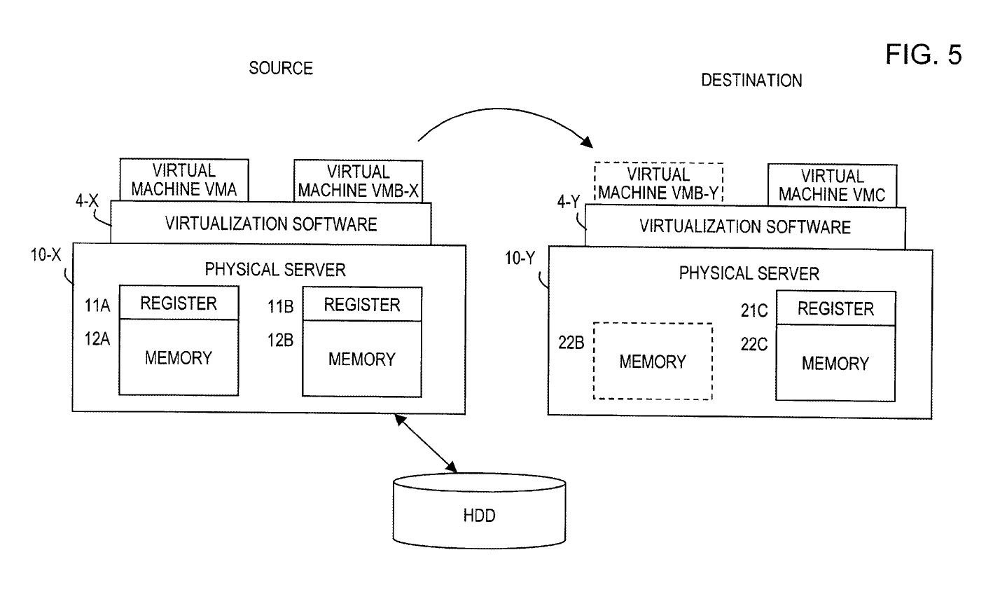

FIG. 4 is a flowchart illustrating the migration process executed by the virtualization software 4. FIGS. 5 to 8 are diagrams for explaining the migration process. The process illustrated in the flowchart of FIG. 4 is described hereinafter with reference to FIGS. 5 to 8.

In response to a migration instruction from the management server 3 (YES in S1), the virtualization software 4 executes a migration process. The migration instruction from the management server 3 includes information identifying a source physical server and a source virtual machine (e.g., IP addresses), information identifying a destination physical server and a destination virtual machine or information specifying any physical server as the destination physical server.

As illustrated in FIG. 5, a source physical server 10-X has two virtual machines VMA and VMB-X operated by virtualization software 4-X. The virtual machines VMA and VMB-X are allocated, respectively, memories 12A and 12B and registers 11A and 11B of the CPU in the physical server 10-X. The source physical server 10-X is connected to a hard disk HDD. The HDD is accessed by the virtual machines VMA, VMB-X. A destination physical server 10-Y, on the other hand, has one virtual machine VMC operated by virtualization software 4-Y. A migration process is executed in which the source virtual machine VMB-X is moved from the source physical server 10-X to the destination physical server 10-Y.

Once the virtual machine VMB-X is activated, the OS, middleware and application in its hard disk HDD are downloaded onto the memory 12B. Once the virtual machine VMB-X is operated, its data are written to the register 11B and memory 12B of the CPU and read therefrom.

The virtualization software 4-X causes the virtualization software 4-Y of the destination physical server to secure a memory space for the destination virtual machine (S2). As a result, a space for a memory 22B is secured in the memory of the destination physical server 10-Y, as illustrated in FIG. 5, constructing a framework of a virtual machine VMB-Y in the destination physical server 10-Y.

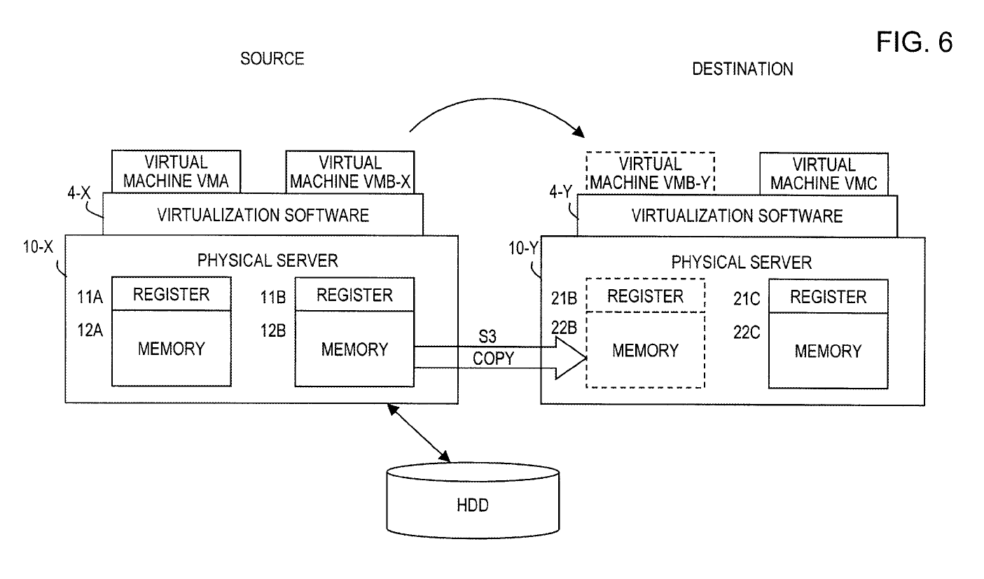

Next, as illustrated in FIG. 6, the virtualization software 4-X transfers and copies the contents (data) stored in the memory 12B of the source virtual machine VMB-X to the memory 22B of the destination virtual machine VMB-Y (S3). This memory content transfer process requires a long processing time. Further, when the running virtual machine VMB-X writes the data into the memory 12B during the memory content transfer process, data of the thus updated page area (difference data) or of a dirty page (difference page) are transferred and copied again from the memory 12B to the memory 22B. This memory content transfer process is continued until the memories 12B, 22B are synchronized with each other. The virtualization software 4-X ends the memory transfer when the volume of the dirty page generated during the memory content transfer becomes small. As a result, contents (data) substantially the same as those of the memory of the running virtual machine VMB-X are written into the memory 22B.

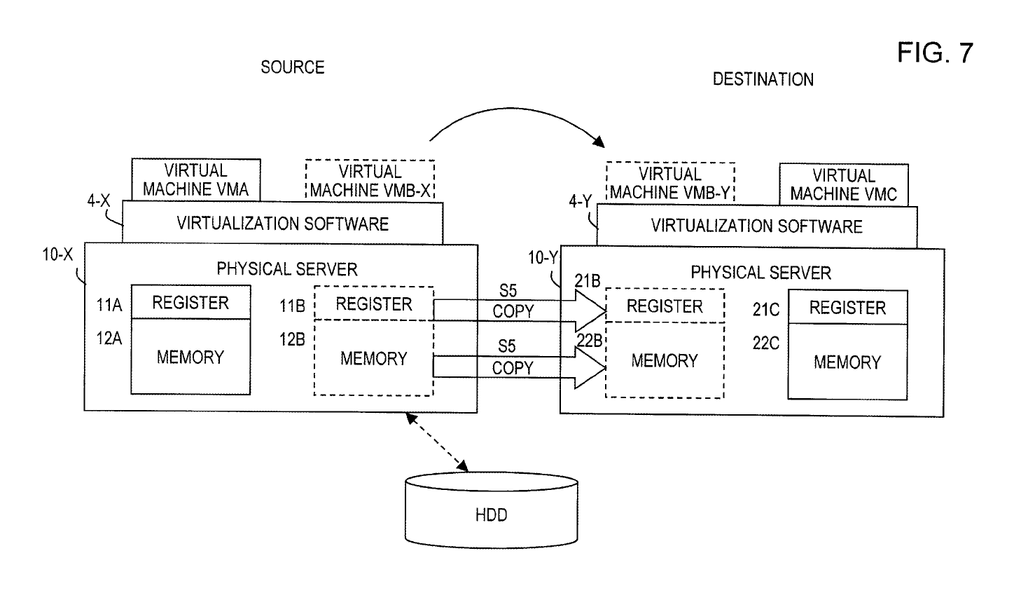

As illustrated in FIG. 7, the virtualization software 4-X suspends the source virtual machine VMB-X (S4). This consequently stops the operation of the source virtual machine VMB-X, which means that further data writing into the memory 12B or data modification in the register 11B of the CPU does not take place.

Suspending a virtual machine means temporarily stopping a virtual machine, and such a process includes a step of stopping allocation of hardware such as a CPU to a virtual machine, a step of saving data or information stored in the memory of the virtual machine onto its hard disk, a step of saving contexts such as a command address sent during the execution of the CPU of the virtual machine and data within various registers (general-purpose register, floating-point register, etc.) onto the hard disk, and a step of opening the hardware resource allocated to the virtual machine.

On the other hand, resuming a virtual machine means restarting a virtual machine that has temporarily been stopped, and such a process includes a step of allocating a hardware resource to the virtual machine, a step of reading the contexts from its hard disk and restoring the contexts in its memory, a step of reading the data or information stored in the memory of the virtual machine from the hard disk and restoring them in the memory, and a step of restarting allocation of hardware such as a CPU to the virtual machine.

After suspending the source virtual machine VMB-X, the virtualization software 4-X transfers the data of the dirty page remaining in the memory 12B of the source virtual machine and the data (contexts) of the register 11B of the CPU to the memory 22B of the destination virtual machine VMB-Y and a register 21B of the CPU (S5), as illustrated in FIG. 7. The amount of data transferred at this stage is very small, and the source virtual machine VMB-X and the destination virtual machine VMB-Y are stopped simultaneously within a short period of time.

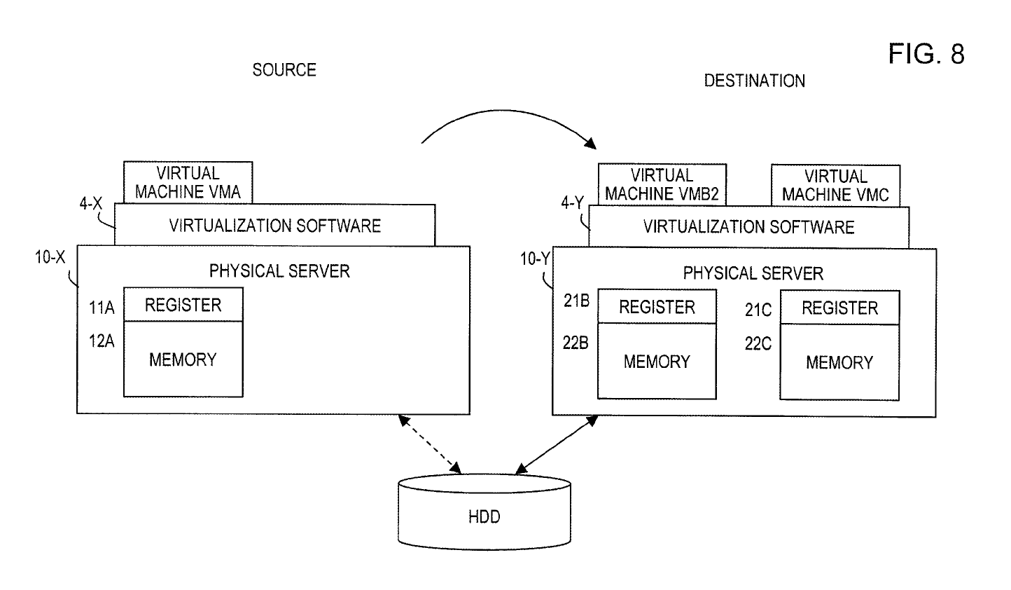

As illustrated in FIG. 8, the virtualization software 4-Y resumes the destination virtual machine VMB-Y (S6). This resuming process is carried out specifically as above. Because the data in the memory 12B and register 11B of the source virtual machine VMB-X are copied to the memory 22B and the register 21B of the CPU of the destination virtual machine VMB-Y, allowing the virtualization software 4-X to resume the destination virtual machine VMB-Y leads to a restart of the operation of the destination virtual machine VMB-Y, the operation being same as that of the source virtual machine VMB-X. The destination virtual machine VMB-Y restarts accessing the hard disk HDD in the same manner as the source virtual machine VMB-X.

Finally, as illustrated in FIG. 8, the virtualization software 4-X deletes the source virtual machine VMB-X (S7). Specifically, the virtualization software 4-X deletes the data stored in the memory 12B and resets the register 11B of the CPU. In this manner, the virtual machine live migration process is completed.

[Memory Content Transfer Process]

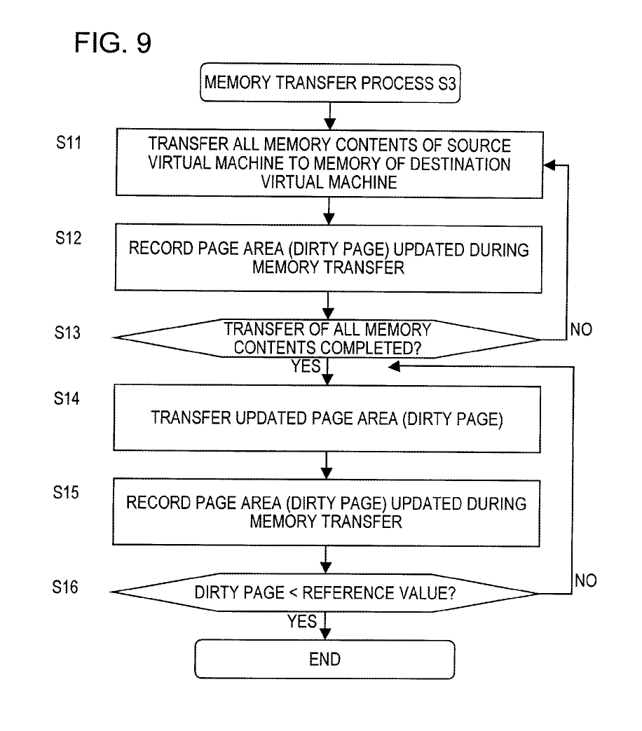

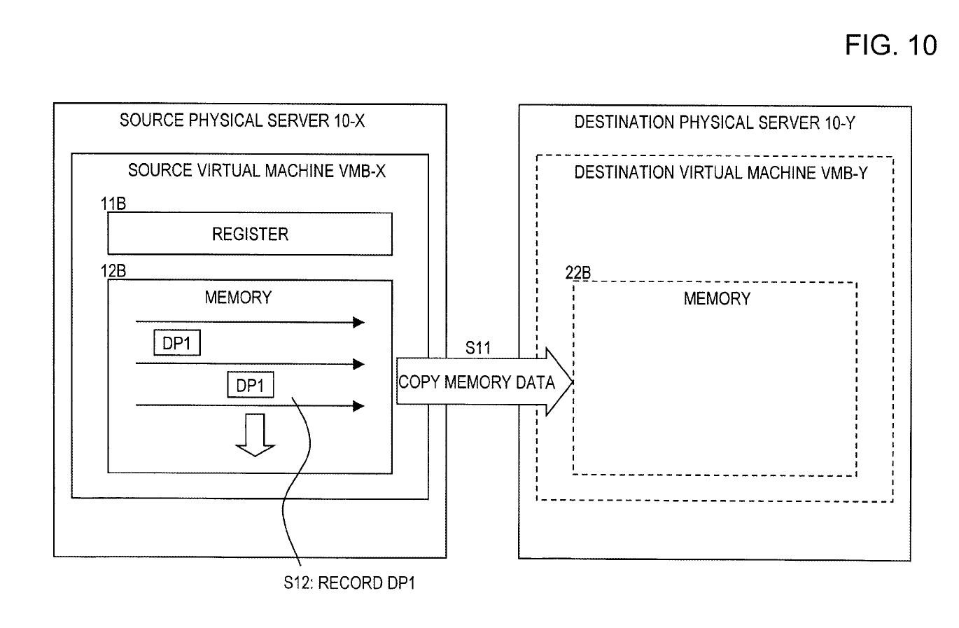

FIG. 9 is a flowchart schematically illustrating the memory content transfer process S3. FIGS. 10, 11 and 12 are diagrams for explaining the memory content transfer process. As illustrated in FIG. 10, the virtualization software 4-X first transfers and copies all memory contents of the memory 12B allocated to the source virtual machine VBM-X of the source physical server 10-X to the memory 22B to be allocated to the destination virtual machine VMB-Y of the destination physical server 10-Y (S11). During this memory content transfer, data writing into the memory 12B is performed by the running source virtual machine VMB-X, thereby generating a dirty page DP1, a page area with the updated data. The virtualization software 4-X records this updated page area (the dirty page DP1) that was updated during the memory transfer (S12).

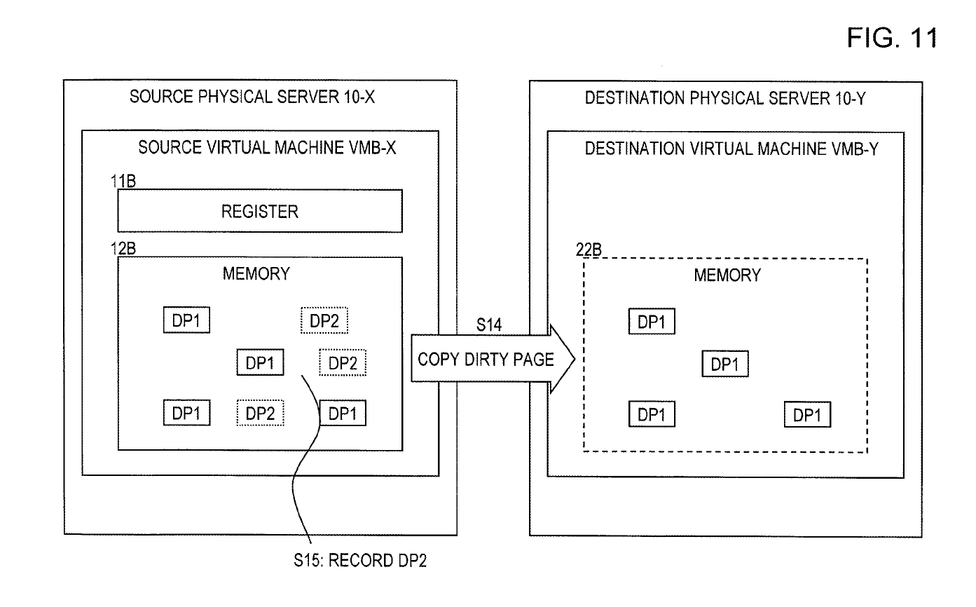

Upon completion of the transfer of all memory contents (YES in S13), the virtualization software 4-X transfers and copies again the dirty page DP1 to the destination memory 22B, the dirty page DP1 being generated within the memory 12B during the transfer of all memory contents (S14), as illustrated in FIG. 11. During the transfer of this dirty page DP1, data writing into the memory 12B is performed again by the running source virtual machine VMB-X, generating a dirty page DP2, a page area with the updated data. The virtualization software 4-X records this updated page area (the dirty page DP2) that was updated during the memory transfer (S15).

The steps S14, S15 are repeated until the volume of dirty pages within the memory 12B becomes less than a reference value (NO in S16). When the volume of dirty pages within the memory 12B becomes less than a reference value (YES in S16), the memory content transfer process ends.

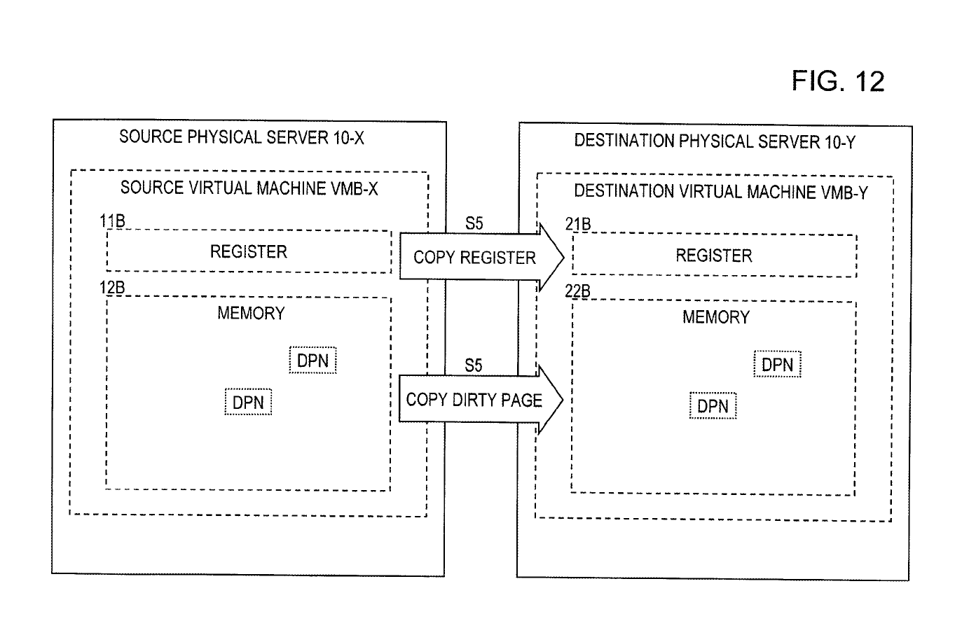

As described with reference to the flowchart illustrated in FIG. 4, the virtualization software 4-X suspends the source virtual machine VMB-X and, as illustrated in FIG. 12, transfers and copies dirty pages DPN remaining in the memory 12B and the data (contexts) stored in the register 11B of the CPU to the memory 22B and the register 21B of the destination virtual machine VMB-Y respectively (S5). Consequently, the destination virtual machine VMB-Y is resumed and the source virtual machine VMB-X is deleted, completing the live migration.

[Memory Transfer During Migration According to the Present Embodiment]

As described with reference to FIG. 9, when, in the migration process, data update in the source memory frequently takes places during transfer of memory contents, the volume of dirty pages to be generated increases. This makes the memory content transfer process continue endlessly, lengthening the time it takes to transfer memory contents. Such an increase in the amount of time required for the memory content transfer process is unfavorable as it leads to an increase in the amount of time it takes to execute the migration process.

In the present embodiment, therefore, the dirty pages corresponding to the page area (unit area of the memory) with lower data update frequencies (or the number of updates performed during a certain period of time, and the same applies hereinafter) are transferred preferentially, so that the dirty pages corresponding to the page areas with higher data update frequencies can be transferred as late as possible. This can eventually reduce the volume of dirty pages generated during the memory transfer and complete the memory transfer within a short period of time.

### First Embodiment

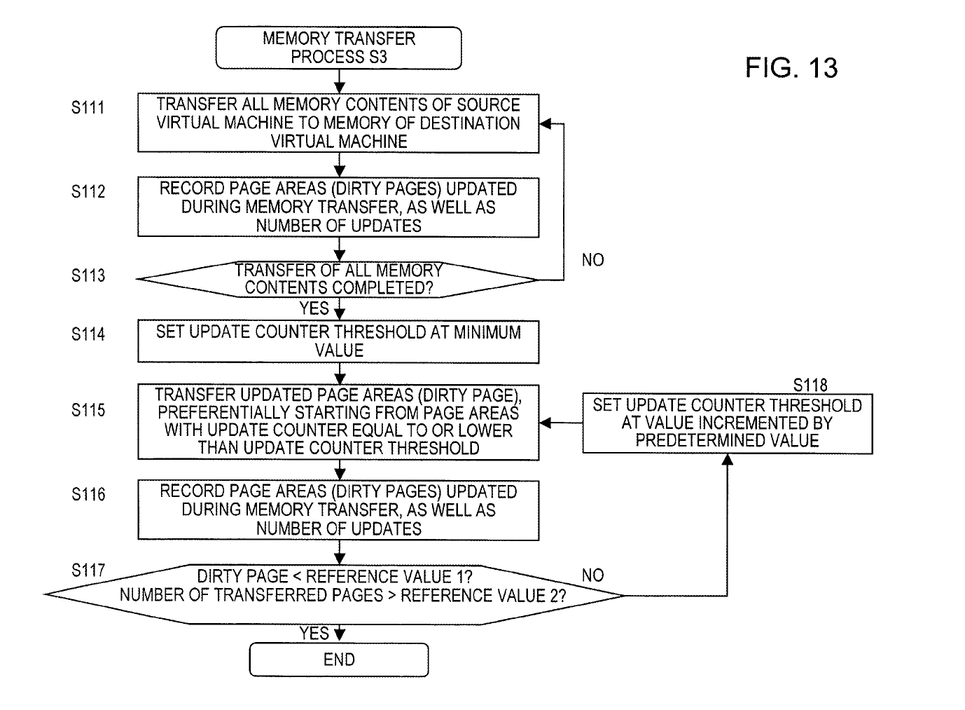

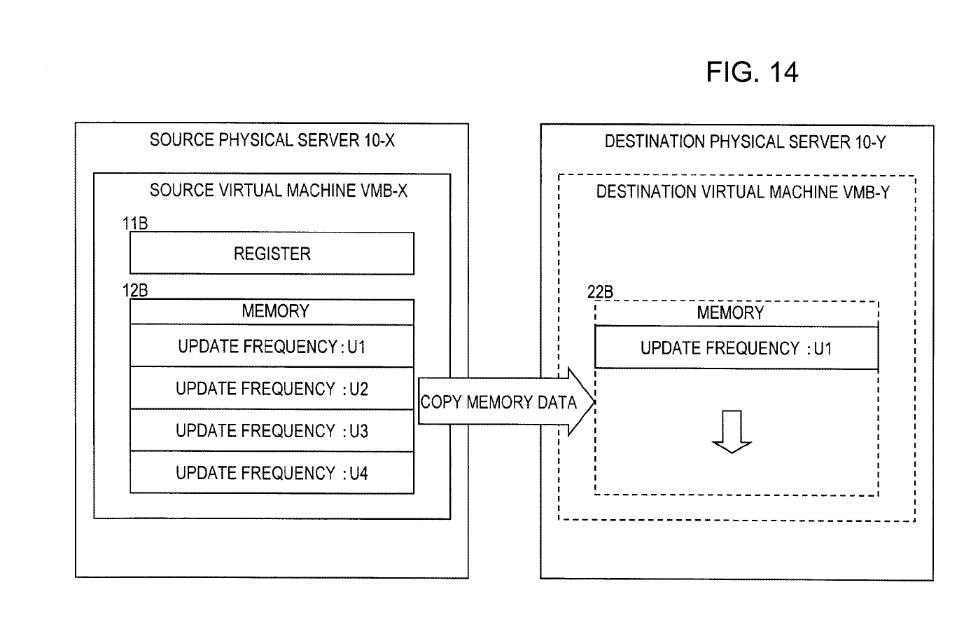

FIG. 13 is a flowchart schematically illustrating a memory content transfer process according to a first embodiment. FIG. 14 is a diagram schematically illustrating the memory content transfer process according to the first embodiment. The virtualization software 4-X transfers and copies all memory contents of the source virtual machine to the memory 22B of the destination physical server that constructs the destination virtual machine (S111). In some cases, while transferring the memory contents, data writing into the memory 12B is performed by the running source virtual machine VMB-X, generating a dirty page DP1 that is a page area with the updated data. In such a case, the virtualization software 4-X records this page area (the dirty page DP1) that was updated during memory transfer, and the number of updates (S112).

This page area is a unit area for transfer and does not have to be a page area. In the example mentioned above, the number of updates to be recorded means how many updates take place during the transfer of all memory contents, and therefore corresponds to the last obtained update frequency. Thus, the virtualization software may only record the number of updates (update count, described hereinafter) for the last certain period of time of the step of transferring all memory contents, e.g., for five minutes, as long as the virtualization software keeps the record of the page areas (update flag, described hereinafter) which were updated during the step of transferring all memory contents.

Upon completion of the whole memory transfer (YES in S113), the virtualization software 4-X sets an update number threshold (update counter threshold) to be used for determining a transfer target page area, to a minimum value (S114). The virtualization software 4-X then prioritizes a dirty page with a lower update frequency out of the dirty pages that area generated in the transfer source memory 12B during transfer of all memory contents, to transfer the memory contents to the destination memory 22B (S115), the dirty page with a lower update frequency being a page area having the number of updates equal to or lower than the update counter threshold. During this transfer of the dirty page DP1, data writing into the memory 12B is performed by the running source virtual machine VMB-X, generating a dirty page. Then, the virtualization software 4-X records this dirty page and the number of dates (S116).

During the whole time when the volume of the dirty page in the memory 12B does not drop to less than a first reference value (NO in S117), the virtualization software 4-X repeats the steps S115, S116 while setting the update counter threshold at a value incremented by a predetermined value (S118). When the volume of the dirty page in the memory 12B becomes less than the first reference value (YES in S117), the memory content transfer is completed.

On the other hand, when not only does the number of transferred dirty pages not exceed a second reference value but also the number of untransferred dirty pages does not drop to less than the first reference value (NO in S117), the virtualization software 4-X repeats the steps S115, S116 while setting the update counter threshold at a value incremented by a predetermined value (S118). The memory content transfer is completed when the volume of the dirty page in the memory 12B becomes less than the first reference value or when the number of transferred dirty pages exceeds the second reference value (YES in S117).

In other words, as illustrated in FIG. 14, the virtualization software 4-X records the number of updates carried out on each of the page areas in the source memory 12B during a certain period. Specifically, the virtualization software 4-X records update frequencies U1 to U4, and transfers the dirty pages, starting from the one with a low update frequency. In this manner, the dirty pages with a higher update frequency are transferred as late as possible, so that the time period between the end of this transfer process and the step S117 of determining when to end the memory transfer becomes short for the dirty pages with higher update frequencies, resulting in a reduction of the volume of dirty pages to be generated by the time of the step S117 of determining when to end the memory transfer.

The condition for ending the memory content transfer process, which is determined in the step S117, may be a first end condition where the number of untransferred pages drops to less than the first reference value, or a second end condition where the number of transferred pages exceeds the second reference value. The number of transferred pages exceeds the second reference value when the number of untransferred dirty pages does not drop to less than the first reference value even after transferring a fair number of dirty pages. In such a case, the memory content transfer process may be force-quit.

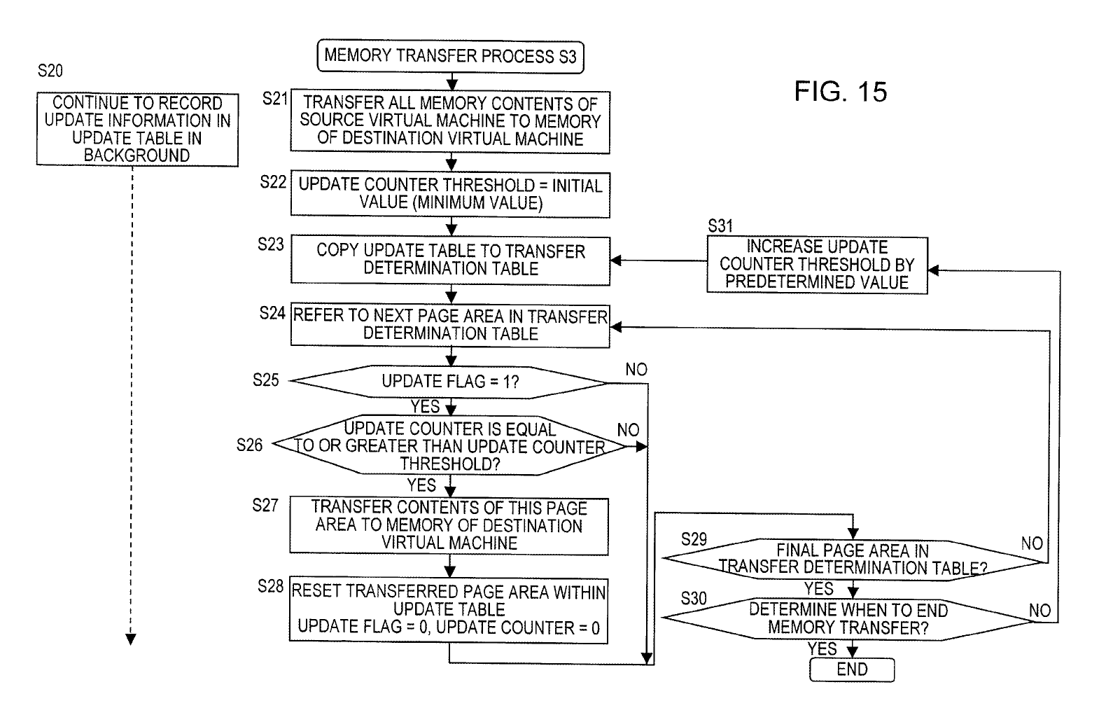

The memory content transfer process according to the first embodiment is now described in more detail. FIG. 15 is a flowchart specifically illustrating the memory content transfer process according to the first embodiment.

First, the virtualization software 4-X continues to record, in an update table in the background, update information indicating that data writing is performed and the data is updated in the memory 12B of the source virtual machine (S20). Then, in the memory content transfer process S3, the virtualization software 4-X transfers all of the memory spaces of the source virtual machine to the memory of the destination virtual machine (S21). This process S20 corresponds to the process S112, S116 illustrated in FIG. 13, and the process S21 to the process S111 of FIG. 13.

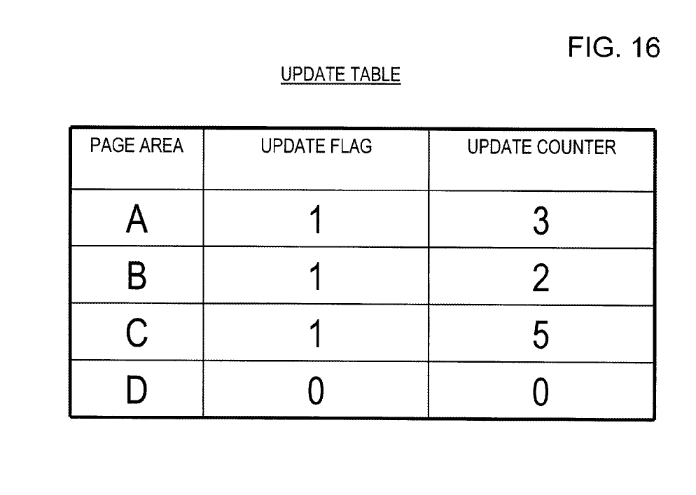

FIG. 16 is a diagram illustrating an example of the update table. The update table has, as the update information for each page area or unit area selected based on a single address in the memory 12B, an update flag indicating whether data writing takes place to update the data, and an update counter indicating the number of updates. Instead of recording the update information with respect to each page area, the update information may be recorded with respect to a plurality of page areas for each memory content transfer. In this update table, the update information is recorded in this manner with respect to each unit area of the memory.

In the example illustrated in FIG. 16, a page area A shows that its update flag is “1,” that the data is updated, i.e., a dirty page is generated, and that its update counter is “3,” which means that the number of updates is three. The same is true in page areas B, C. A page area D shows that its update flag is “0,” that the data is not yet updated, i.e., a dirty page is not generated, and therefore that its update counter is “0.”

The value of each update counter indicates the number of updates. This means that the value of each update counter measured within a certain period of time indicates an update frequency.

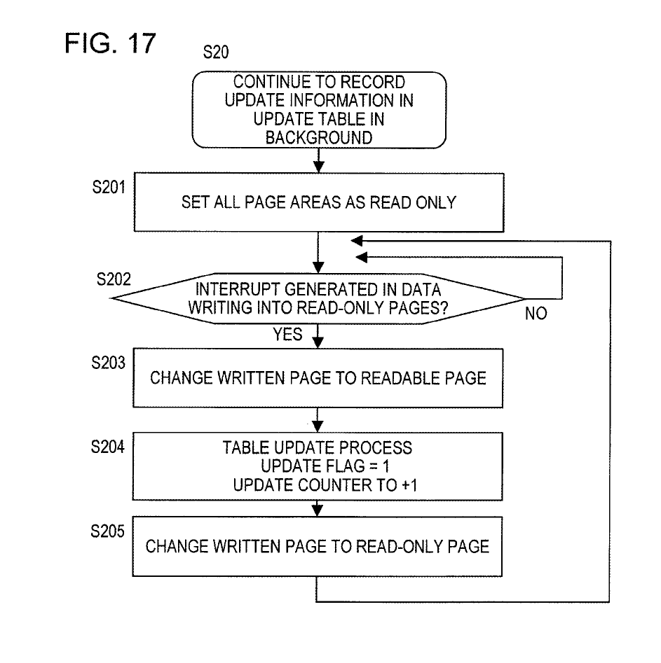

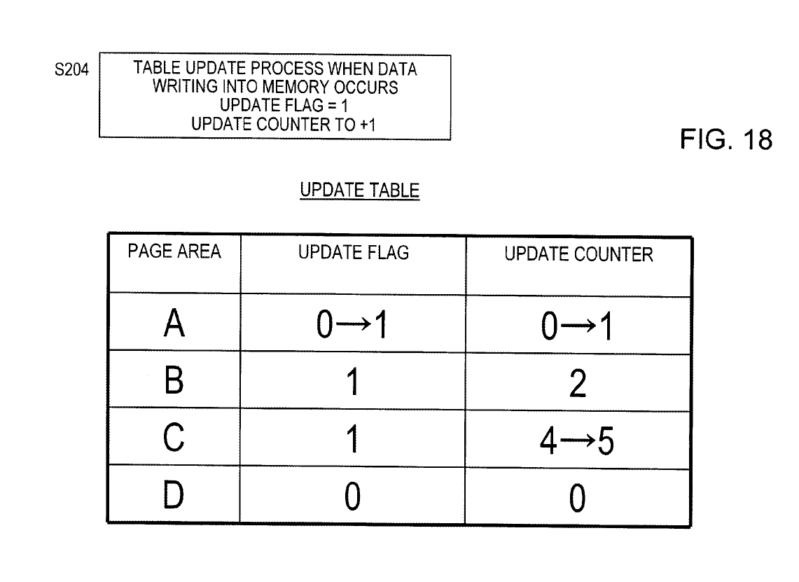

FIG. 17 is a flowchart illustrating how the update information (the update flags and the number of updates) are recorded in the update table in step S20. FIG. 18 is a diagram illustrating a table update process S204.

In FIG. 17, the virtualization software (hypervizor) 4-X sets all of the page areas of the memory 12B as read only (S201). When the source virtual machine VMB-X tries to write data into one of the read-only page areas of the memory 12B, the virtualization software 4-X causes an interrupt because such writing is considered a violation (YES in S202). The virtualization software 4-X therefore changes the written page area into a writable page (S203). Accordingly, the source virtual machine VMB-X executes a writing process.

The virtualization software 4-X can detect the writing process that is executed on the memory 12B by the source virtual machine VMB-X, by causing an interrupt due to the violated writing described above. The virtualization software 4-X executes the table update process (S204). In other words, the virtualization software 4-X sets the update flag corresponding to the written page area at “1” and the update counter thereof at “+1.” When the update flag is already set at “1,” the virtualization software 4-X sets the update counter at “+1” without changing the update flag.

FIG. 18 is a diagram illustrating the table update process S204 which is carried out when data writing into the memory occurs. According to the example illustrated in FIG. 18, the update flag of the page area A is changed from “0” to “1” and the update counter of the same is increased from “0” to “1” by “+1.” In the page area C, since the update counter is already “1,” the update counter is changed from “4” to “5” by “+1.”

In FIG. 17, subsequent to the update process S204, the virtualization software 4-X changes the written page area into a read-only page (S205). When data writing takes place thereafter, which is a violation and therefore causes an interrupt, the virtualization software 4-X detects such violated data writing.

In FIG. 15, upon completion of transfer of all memory contents of the memory 12B into the memory 22B (S21), the virtualization software 4-X performs a preparation process for setting the update counter threshold at a minimum value, an initial value (S22). The virtualization software 4-X then copies the update table recorded during the step S21 of transferring all memory contents, which is executed in the background, to a transfer determination table (S23). This transfer determination table is a copy of the update table illustrated in FIG. 18 and is referenced when determining whether to re-transfer the page area (dirty page) that is updated during the process S21 for transferring all memory contents, subsequent to the process S21.

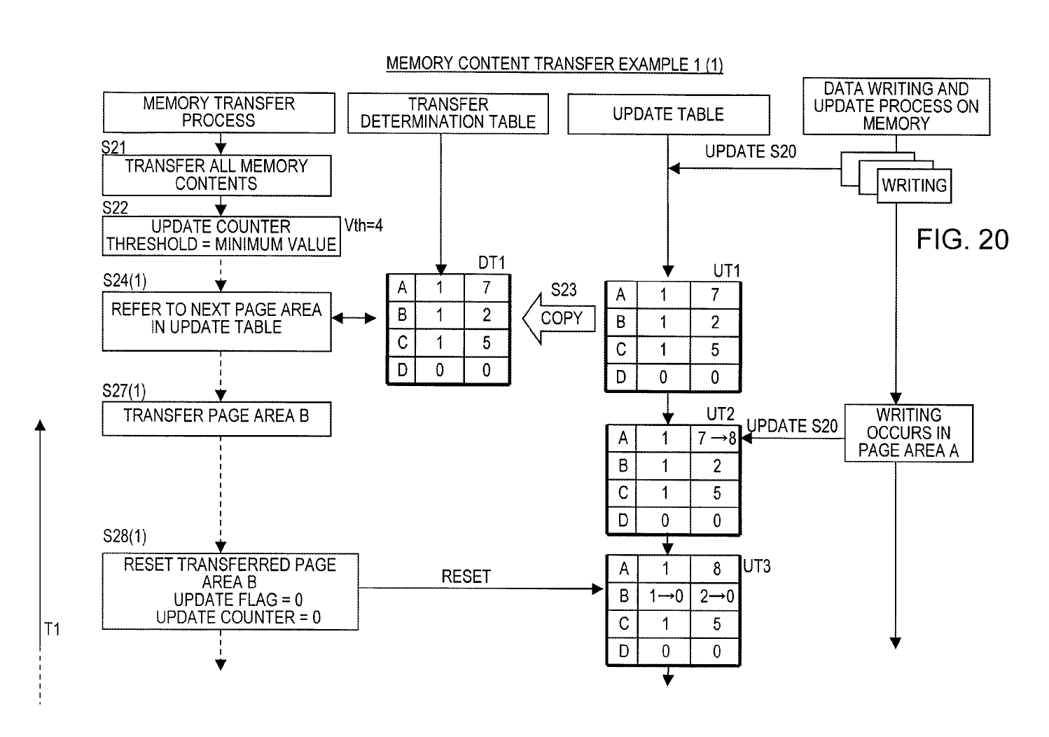

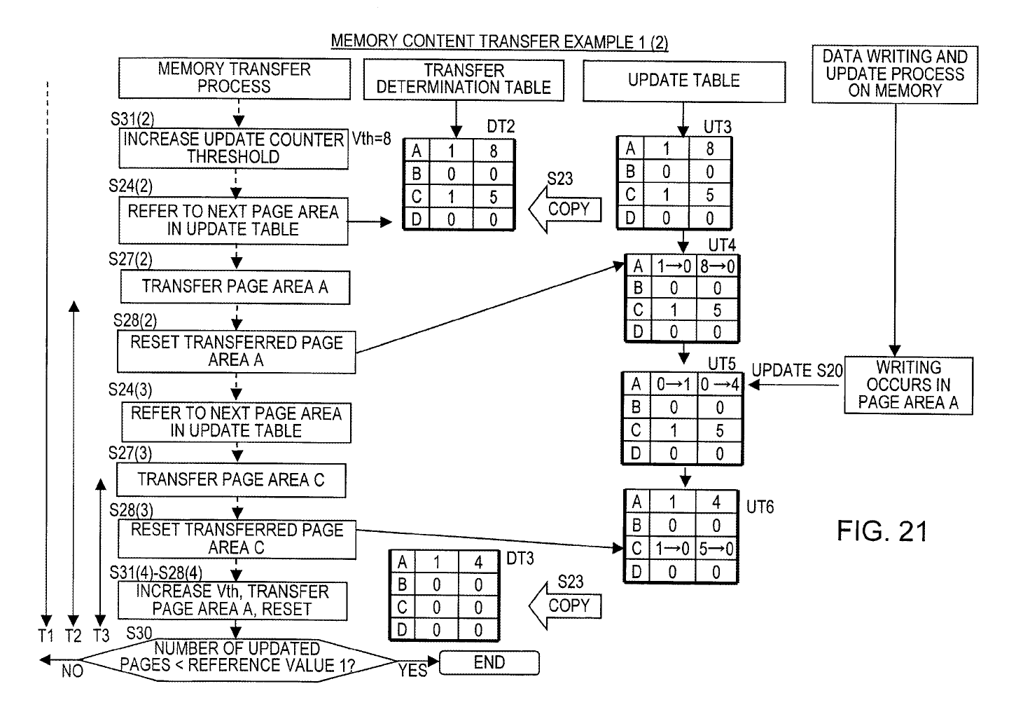

FIGS. 20 and 21 are diagrams each illustrating a first specific example of the memory content transfer process. As will be described hereinafter in detail, FIG. 20 illustrates that an update table UT1, which is updated during the step of transferring all memory contents (S21), is copied to a transfer determination table DT1 (S23).

Next, the virtualization software 4-X performs a dirty page re-transfer process. The virtualization software 4-X first refers sequentially to the page areas stored in the update determination table (S24). When the update flags of the referenced page areas are “1” (YES in S25) and the update counters of the same are equal to or less than the update counter threshold (YES in S26), the virtualization software 4-X transfers the contents (data) of the page areas to the memory 22B of the destination virtual machine (S27), and resets the update flags and update counters of the transferred dirty page areas of the update table to “0” (S28). When the conditions, under which the update flags of the referenced page areas of the transfer determination table are “1” and the update counters are equal to or less than the update counter threshold, are not satisfied (NO in S25 or S26), the virtualization software 4-X does not transfer the memory contents of the referenced page areas.

In the example illustrated in FIG. 20, the page area B of the transfer determination table DT1, which satisfies the conditions by which the update flag is “1” and the update counter value is equal to or less than the update counter threshold, is transferred (S27 (1)). Subsequently, the update flag and the update counter of the page area B in an update table UT3 is reset to “0” (S28 (1)).

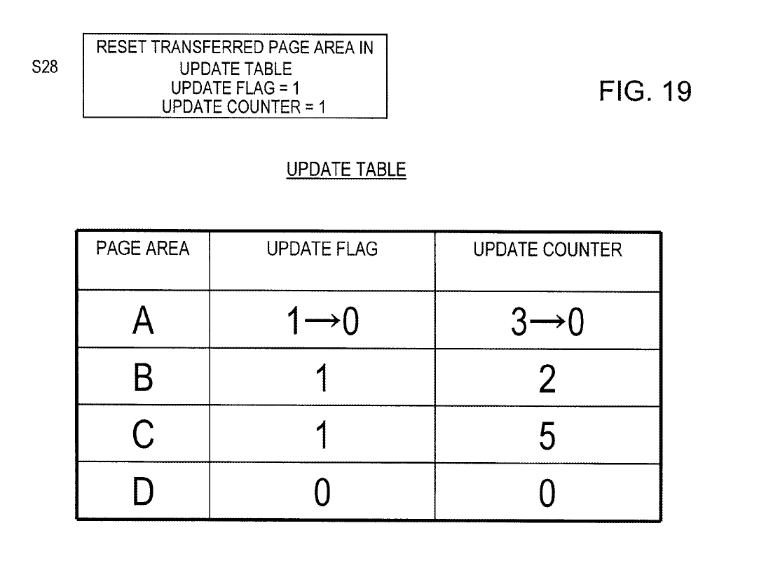

FIG. 19 is a diagram illustrating the process S28 for resetting the transferred page areas in the update table. The update table illustrated in FIG. 19 represents an example in which the page area A is transferred, wherein the update flag of the page area A is changed from “1” to “0” and the update counter from “3” to “0.” The page area B illustrated in FIG. 20 is also set in the same manner.

The virtualization software 4-X repeats the processes S24 to S28 until the final page area of the transfer determination table (NO in S29). As a result, all of the contents of the page area (dirty page) having the update flag “1” and the update counter value equal to or less than the set update counter threshold (the initial value, which is the minimum value, at this moment) are transferred to the destination memory.

The virtualization software 4-X then carries out memory transfer completion determination, as in step S117 illustrated in FIG. 13 (S30). In this memory transfer completion determination the virtualization software refers to the update table to determine a first condition in which the number of untransferred dirty pages drops to less than the first reference value, and a second condition in which the number of times the dirty pages are transferred exceeds the second reference value, which is a predetermined multiple of the number of page areas in the memory 12B. When the first or second condition is satisfied, the memory transfer process is completed (YES in S30). In other words, while the first condition is provided to determine whether the number of dirty pages is significantly reduced or not, the second condition is provided to determine whether memory transfer is force-quit due to a high memory update frequency.

When the result of the memory transfer completion determination is NO (NO in S30), the virtualization software 4-X raises the update counter threshold by a predetermined value (S31) and repeats the processes S23 to S30. In other words, the virtualization software 4-X copies the update tables that have been recorded in the past, to the transfer determination table, and, with reference to this transfer determination table, carries out the process for transferring a dirty page having the update counter value equal to or less than the new update counter threshold.

As a result of increasing the update counter threshold, the memory content transfer process is performed in the subsequent processes S23 to S30 on the dirty pages with a higher update frequency. Specifically, the dirty pages with a higher update frequency is subjected to the transfer process before the dirty pages with a lower update frequency are. Consequently, the time period between the end of the transfer process and the memory transfer completion determination becomes shorter for the page areas with higher update frequencies than for the page areas with lower update frequencies, resulting in a reduction of the number of new dirty pages. This will be described hereinafter using specific examples.

### Memory Content Transfer Example 1

The memory content transfer process S3 illustrated in the flowchart of FIG. 15 is now described using a transfer example 1. In this transfer example 1, the memory content transfer process S3 is completed when memory contents of a source virtual machine are transferred and the number of remaining, untransferred dirty pages drops to less than the first reference value.

FIGS. 20 and 21 are diagrams illustrating this memory content transfer example 1. The memory transfer process is illustrated on the left-hand side of each of the diagrams in correspondence with the specific examples, wherein the number provided to each step corresponds to the number provided to each of the steps illustrated in the flowchart of FIG. 15. The middle of each of the diagrams illustrates changes in the transfer determination table and the update table, and the right-hand side of each of the diagrams illustrates data writing performed on each memory and updates of the update tables.

The virtualization software 4-X first transfer all memory contents (S21). In response to writing processes performed on the memories during transfer of all memory contents, the virtualization software updates the update tables and records the writing processes (S20). As a result, as soon as the process S21 for transferring all memory contents is finished, the update table UT1 is generated. The update table UT1 at this stage shows that the update flags of the page areas A, B, C are “1” and the update counters “7,” “2,” “5.” The virtualization software 4-X copies this update table UT1 to the transfer determination table DT1 (S23). The update counter values in this transfer determination table DT1 are the number of times writing takes place during the process for transferring all memory contents, and therefore represent the last update frequencies.

The virtualization software 4-X therefore sets the update counter threshold at the minimum value (e.g., Vth=4) (S22). The virtualization software then searches through the page areas in the transfer determination table DT1 sequentially from the top (S24 (1)) to detect a page area (dirty page) that has the update flag “1” and the update counter equal to or less than the update counter threshold (Vth=4), determines that the page area B is a dirty page to be transferred, and then transfers the data of the page area B (S27 (1)).

During transfer of the data of the page area B, data writing into the page area A takes place, which is consequently recorded in the update table. The update counter value of the page area A is increased by +1, and thereby the update table is changed to the update table UT3 (S20). Upon completion of the transfer process S27 (1) on the page area B, the virtualization software resets the update flag of the transferred page area B in the update table UT3 to “0” and the update counter to “0” (S28 (1)). Consequently, the completion of the transfer of the page area B is recorded. The transfer determination table DT1 does not have any page areas other than the page area B that have the update counter equal to or less than the update counter threshold Vth=4.

As illustrated in FIG. 21, therefore, the virtualization software changes the update counter threshold to Vth=8 (S31 (2)) and copies the update table UT3 to a transfer determination table DT2 (S23). The virtualization software then searches through the page areas in the transfer determination table DT2 sequentially from the top (S24 (1)) to detect a page area (dirty page) that has the update flag “1” and the update counter equal to or less than the update counter threshold (Vth=8), determines that the page area A is a dirty page to be transferred, and then transfers the data of the page area A (S27 (2)). The virtualization software then resets the updated record of the transferred page area A in an update table UT4 (S28 (2)). The virtualization software further searches the transfer determination table DT2 (S24 (3)) to detect a page area C, transfers the page area C (S27 (3)), and resets the data of the transferred page area C in the update table DT6 (S28 (3)).

During transfer of the page area C, data writing into the page area A takes place four times. Accordingly, the update flag of the page area A is changed to “1” and the update counter to “4,” as shown in an update table UT5 (S20). In other words, the page area A is a new dirty page.

The virtualization software therefore increases the update counter threshold and changes the threshold to Vth=12, and copies an update table UT6 to a transfer determination table DT3. The virtualization software then searches through the page areas in the transfer determination table DT3 sequentially from the top, determines that the page area A is a dirty page to be transferred, transfers the data of the page area A, and resets the data of the transferred page area A in the update table UT6 (S31 (4) to S28 (4)). The virtualization software then detects that the number of dirty pages remaining in the update table UT6 is less than the first reference value (5, in this example) (YES in S30), and ends the memory content transfer process.

As illustrated on the left-hand side of FIGS. 20 and 21, in the transfer completion determination step S30, a time T2 that elapses since the end of transfer of the page area A with a high transfer frequency is shorter than a time T1 that elapses since the end of transfer of the page area B with a low transfer frequency, but a time T3 that elapses since the end of transfer of the page area C is even shorter. This means that, although the time T1 that elapses since the end of transfer is long, the probability of the occurrence of new data writing into the page area B is low due to the low transfer frequency of the page area B. On the other hand, because the times T2, T3 that elapse since the end of transfer are short in spite of the high transfer frequencies of the page areas A, C, the probability of the occurrence of new data writing into the page areas A, C is also low. Therefore, preferentially transferring the page areas with low transfer frequencies leads to an effective reduction in the volume of untransferred dirty pages and hence the amount of time required for the memory content transfer process.

### Memory Content Transfer Example 2

A memory content transfer example 2 is described next. In this example 2, memory content transfer illustrated in the flowchart of FIG. 15 is executed, wherein the memory content transfer process is force-quit when the number of untransferred update pages or dirty pages does not drop to less than the first reference value (5, in this example) even when the number of transferred pages exceeds the second reference value (15 pages, in this example).

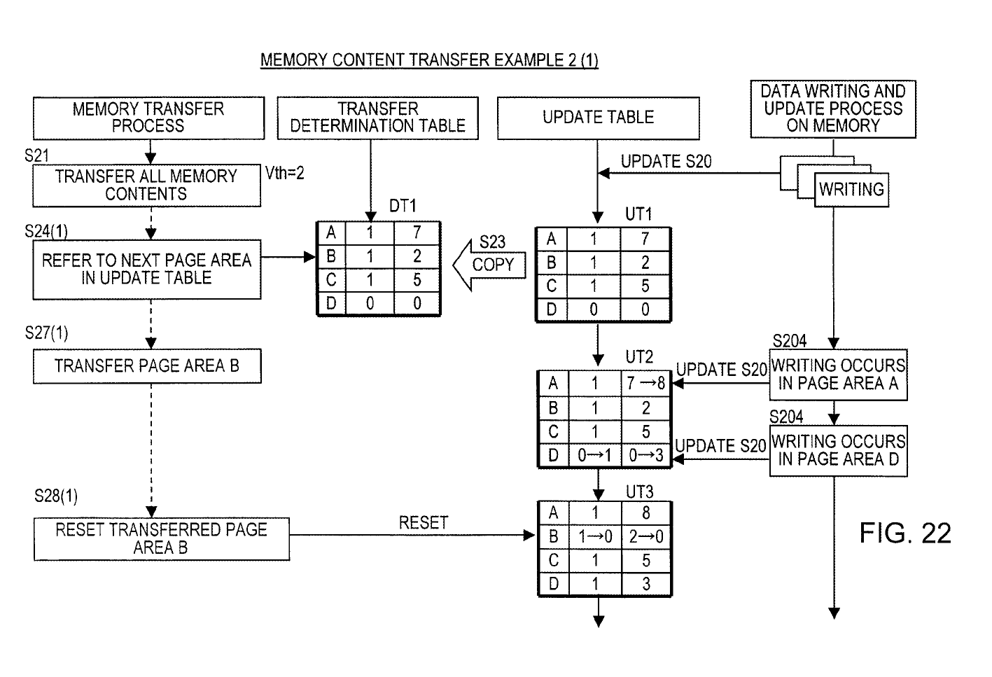

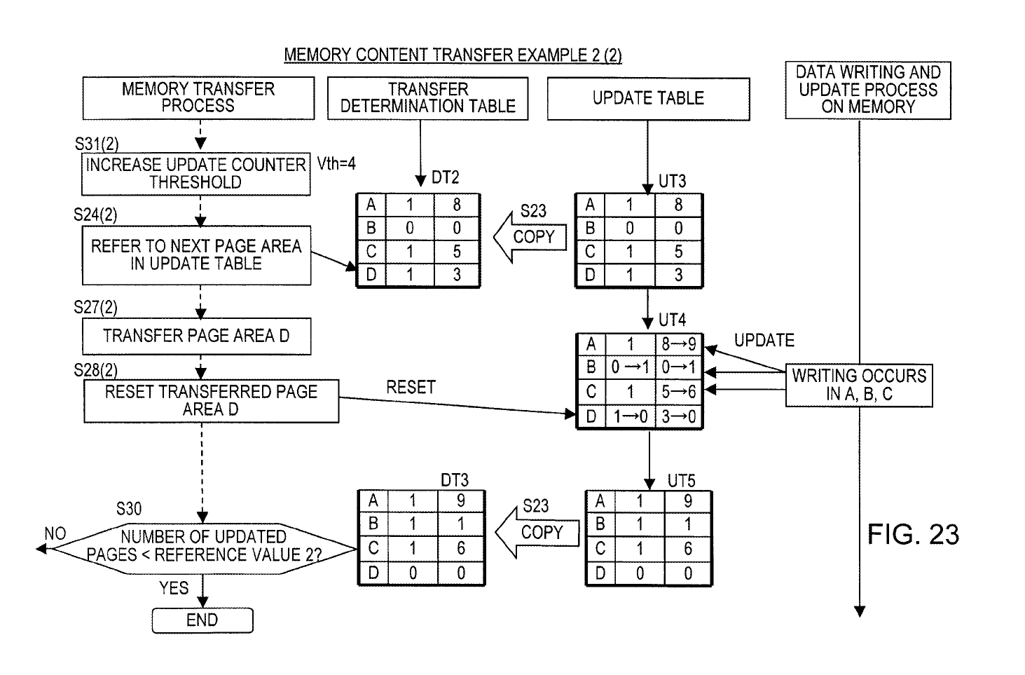

FIGS. 22 and 23 are flowcharts illustrating the memory content transfer example 2. As with FIGS. 20 and 21, the update process flows from the memory transfer process illustrated on the left-hand side, the transfer determination table, the update table, and data writing into a memory.

The virtualization software first transfers all memory contents (S21). The virtualization software then sets the update counter threshold at the minimum value, which is Vth=2 in this transfer example 2, and copies the update table UT1 to the transfer determination table DT1 (S23). The virtualization software then searches the transfer determination table DT1 from the top to detect the page area B that has the update flag “1” and the update counter equal to or less than Vth=2, and transfers the contents of the page area B (S27 (1)). In response to data writing occurring in the page areas A, C during transfer of the page area B, the virtualization software updates the update gable (S20). Upon completion of transfer of the page area B, the virtualization software then resets the transferred page area C in the update table UT3 (S28 (1)).

In FIG. 23, the virtualization software increases the update counter threshold and changes the threshold to Vth=4 (S31 (2)), and copies the update table UT3 to the transfer determination table DT2 (S23). In the same manner described above, the virtualization software then searches the transfer determination table DT3 from the top (S31 (2)), transfers the contents of the page area D (S27 (2)), and resets the transferred page area D in the update table UT4 (S28 (2)). However, a large volume of data are written into the memory during transfer of the page area D, which increases the update counter values of the page areas A, B, C.

The virtualization software then detects that the number of transferred dirty pages exceeds the second reference value (YES in S30) before the number of untransferred dirty pages of the update table UT5 drops to less than the first reference value, and force-quits the memory content transfer process.

### Second Embodiment

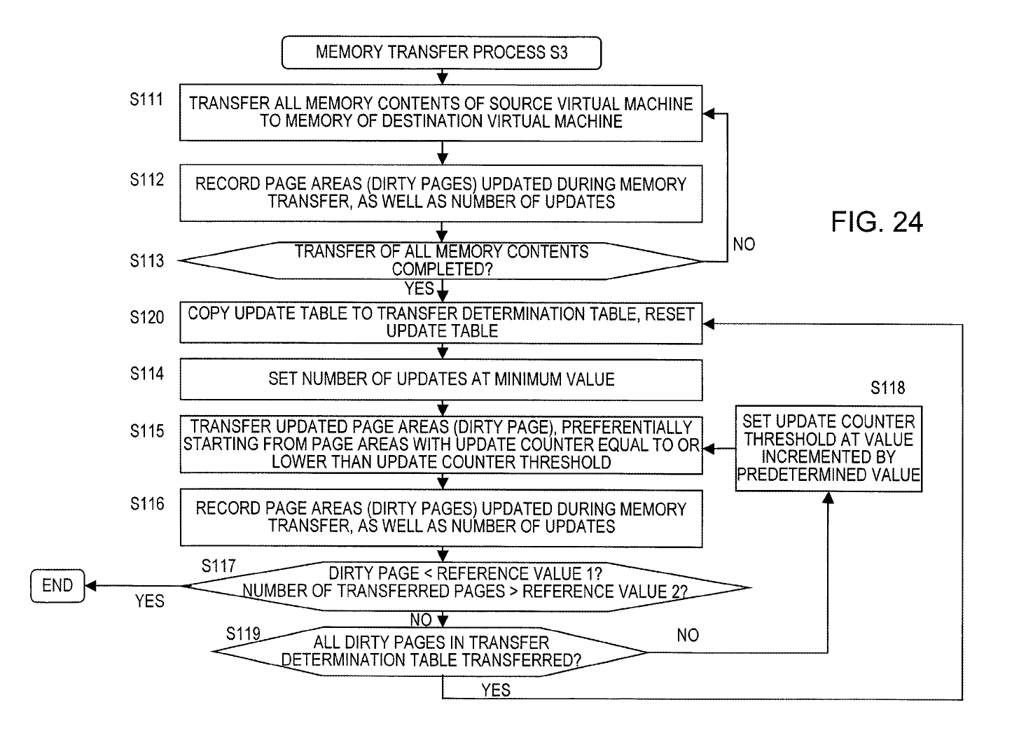

FIG. 24 is a flowchart schematically illustrating a memory content transfer process according to a second embodiment. The difference with the flowchart illustrated in FIG. 13 of the first embodiment is that the flowchart illustrated in FIG. 24 has steps S120, S119.

In the second embodiment, the virtualization software first transfers all memory contents (S111, S112, S113). Upon completion of transferring all memory contents (YES in S113), a process for re-transferring a dirty page created during transfer of all memory contents is executed (S114 to S120). These steps are the same as those of the first embodiment. In this process for re-transferring a dirty page, the virtualization software copies the update table to the transfer determination table and resets the transfer determination table (S120). The virtualization software then searches the transfer determination table from the top and detects and transfers a dirty page having the update counter equal to or lower than the update counter threshold (S115). The virtualization software repeats the processes S115 to S118 while increasing the update counter threshold from the minimum value (S114, S118) until all dirty pages within the transfer determination table are transferred (YES in S119). Data writing into the memory that occurs during transfer of the dirty pages of the transfer determination table is recorded in the update table (S116). In this manner, the latest occurrence of a dirty page can be reflected on the number of updates on the update table, and the update table is reset in each re-transfer cycle (S120). Thus, the number of updates on the update table reflects the transfer frequency obtained in each re-transfer cycle.

When the conditions for completing the memory content transfer process are not satisfied (NO in S117) even after completion of transferring all dirty pages of the transfer determination table (YES in S119), the virtualization software copies the update table to the transfer determination table and resets the update table again (S120). The virtualization software executes the steps S114 to S118 again. The transfer determination table at this stage that is obtained by copying the update table reflects the latest occurrence of a dirty page. Thus, preferentially transferring dirty pages having smaller update counters can effectively prevent the occurrence of a dirty page.

In this manner, the virtualization software preferentially re-transfers the first group of dirty pages of the update table that have smaller update counter values and are generated after completion of transfer of all memory contents, and then records a new dirty page generated during re-transfer into the reset update table. Once this re-transfer of the first group of dirty pages is completed, the virtualization software similarly and preferentially transfers the second group of dirty pages that have smaller update counter values and are generated during re-transfer, and records a new dirty page generated during re-transfer into the reset update table. The number of dirty pages generated in each re-transfer cycle can be reduced and the amount of time required for the memory content transfer process can be shortened, by repeating this process for preferentially transferring dirty pages having smaller update counter values.

### Memory Content Transfer Process Example 3

The process illustrated in the flowchart of FIG. 24 is described next based on specific examples.

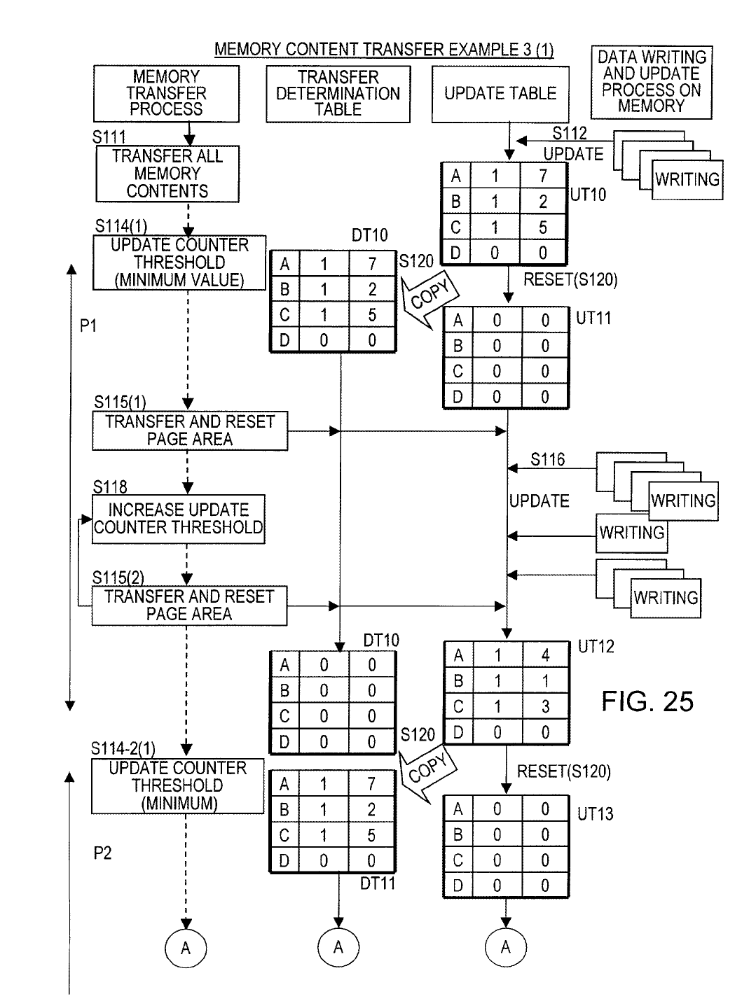

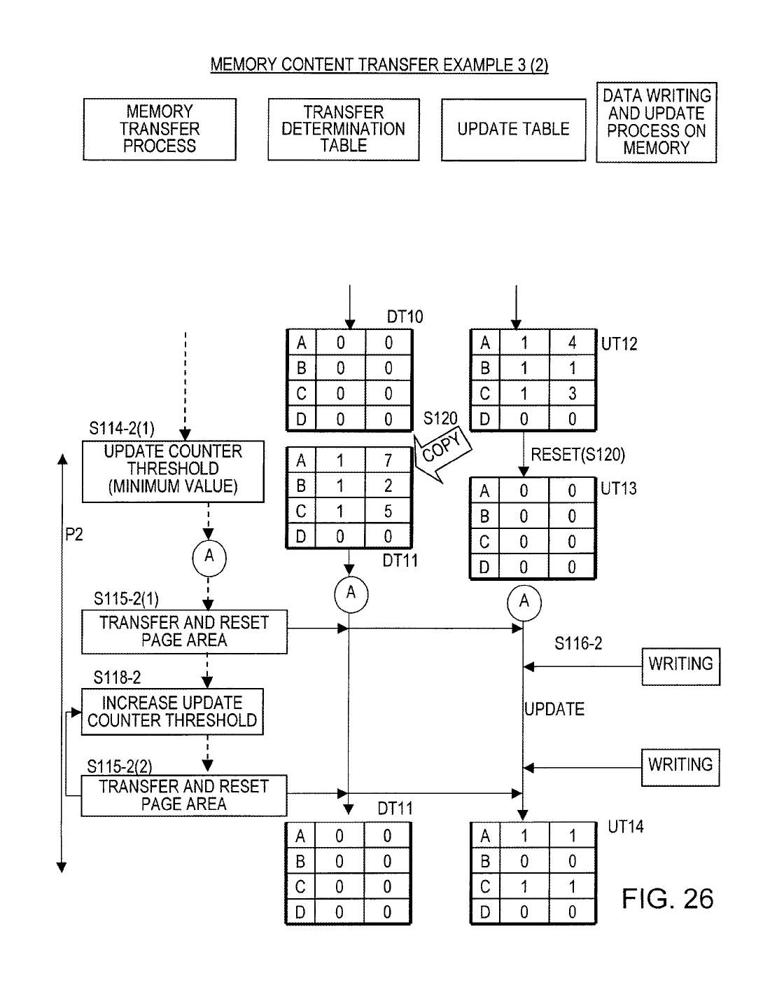

FIGS. 25 and 26 are flowcharts illustrating a memory content transfer example 3 according to the second embodiment. As illustrated in FIG. 25, the virtualization software records the occurrence of a dirty page onto an update table UT10 (S112) while transferring all memory contents (S111). Upon completion of transferring all memory contents, the virtualization software copies the update table UT10 to a transfer determination table DT10 and resets the update table UT10 to an update table UT11 (S120).

From this point on, a first cycle P1 of dirty page re-transfer process begins. The virtualization software sets the update counter threshold Vth at the minimum value (S114 (1)), searches the transfer determination table DT10 to detect a dirty page that has the update counter value equal to or lower than the update counter threshold, transfers the detected page area, and resets the update flag and update counter of the transferred page area in the transfer determination table DT10 and the update table UT11 (S115 (1)). The virtualization software further searches the transfer determination table DT10 and repeats the same steps while increasing the update counter threshold Vth (S118). A new dirty page that is generated during the first cycle P1 of dirty page re-transfer process is recorded by the virtualization software, in the update table UT11 that is reset in the step S120 (S116).

When all of the dirty pages in the transfer determination table DT10 are transferred as a result of the first cycle P1 of dirty page re-transfer process, the virtualization software starts a second cycle P2 of dirty page re-transfer process. In other words, in the second cycle P2 the virtualization software executes a process for re-transferring a dirty page generated in the first cycle P1.

As illustrated at the end of FIG. 25 and the beginning of FIG. 26, in the second cycle P2 the virtualization software copies an update table UT12 to a transfer determination table DT11 and resets the update table UT12 to an update table UT13, as with the first cycle P1 (S120). The virtualization software then sets the update counter threshold Vth at the minimum value (S114-2 (1)), searches the transfer determination table DT11 to detect a dirty page having the update counter value equal to or lower than the update counter threshold, transfers the detected page area, and resets the update flag and update counter of the transferred page area of the transfer determination table DT11 and the update table UT13 (S115-2 (1)). The virtualization software further searches the transfer determination table DT10 and repeats the same steps while increasing the update counter threshold Vth (S118-2). A new dirty page that is generated during the second cycle P12 of dirty page re-transfer process is recorded by the virtualization software, in the update table UT13 that is reset in the step S120 (S116-2).

The virtualization software then detects that the number of untransferred dirty pages in the transfer determination table DT11 and in the update table UT14 drops to less than the first reference value, and ends the memory content transfer process. This process for determining when to end the memory content transfer process is not illustrated in FIG. 26.

In the second embodiment described above, the update table and the update counter threshold are reset in each dirty page re-transfer cycle. And in each dirty page re-transfer cycle, while the dirty pages with smaller update counter values indicating the update frequency of the transfer determination table are preferentially transferred, the dirty pages with higher update counter values or update frequencies are transferred later. As a result, the number of dirty pages to be generated can be reduced, as well as the amount of time required for the memory content transfer process.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer readable medium that stores therein a migration processing program for causing a computer to execute a process comprising:
transferring memory data stored in a memory of a source virtual machine generated on a source physical server from a memory of the source physical server to a memory of a destination physical server;
measuring, with respect to each unit area of the memory, an update frequency at which data in the memory of the source physical server are updated by the source virtual machine;
re-transferring, from the memory of the source physical server to the memory of the destination physical server, the memory data that are updated by the source virtual machine during the transferring the memory data such that data in a unit area with a first update frequency are preferentially re-transferred over data in a unit area with a second update frequency higher than the first update frequency; and
suspending the source virtual machine and then resuming a destination virtual machine on the destination physical server.

2. The non-transitory computer readable medium according to claim 1, wherein, when the memory data in the memory of the source virtual machine are updated and the number of untransferred unit areas is less than a first reference value during the re-transferring the memory data, the re-transferring the memory data is ended, and the resuming and the suspending is executed.

3. The non-transitory computer readable medium according to claim 2, wherein, when, during the re-transferring the memory data, the memory data in the memory of the source virtual machine are updated and the number of untransferred unit areas is not less than the first reference value even after the number of re-transferred unit areas exceeds a second reference value, the re-transferring the memory data is ended, and the resuming and the suspending is executed.

4. The non-transitory computer readable medium according to claim 1, wherein
in the measuring the update frequency, recording a data update frequency in an update table for each unit area of the memory, and
in the re-transferring the memory data, referring to the update frequencies in a transfer determination table which is a copy of the update table, re-transferring data in a unit area having an update frequency equal to or lower than a first threshold, and then re-transferring data in a unit area having an update frequency equal to or lower than a second threshold higher than the first threshold.

5. The non-transitory computer readable medium according to claim 4, wherein in the measuring the update frequency, recording, in the update table, the number of data updates taking place during the transferring the memory data as the update frequencies, and recording, in the update table, the number of data updates taking place during the re-transferring the memory data as the update frequencies.

6. The non-transitory computer readable medium according to claim 4, wherein, when the data in the updated unit area are transferred during the re-transferring the memory data, resetting the update frequency of the transferred unit area that is stored in the update table.

7. The non-transitory computer readable medium according to claim 6, wherein in the re-transferring the memory data copying the update table to the transfer determination table and repeating a process for re-transferring the data of each unit area based on the first threshold and the second threshold, each time when transfer of all data in the updated unit areas stored in the transfer determination table is ended.

8. The non-transitory computer readable medium according to claim 4, wherein in the re-transferring the memory data, transferring the data in the updated unit area based not only on the first and second thresholds but also on a third threshold higher than the second threshold.

9. A migration processing method for causing a computer to execute a migration process for moving a source virtual machine generated on a source physical server to a destination physical server,
the migration process comprising:
transferring memory data stored in a memory of the source virtual machine from a memory of the source physical server to a memory of the destination physical server;
measuring, with respect to each unit area of the memory, an update frequency at which data in the memory of the source physical server are updated by the source virtual machine;
re-transferring, from the memory of the source physical server to the memory of the destination physical server, the memory data that are updated by the source virtual machine during the transferring the memory data such that data in a unit area with a first update frequency are preferentially re-transferred over data in a unit area with a second update frequency higher than the first update frequency; and
suspending the source virtual machine and then resuming a destination virtual machine on the destination physical server.

10. The migration processing method according to claim 9, wherein
in the measuring the update frequency, recording a data update frequency in an update table for each unit area of the memory, and
in the re-transferring the memory data, referring to the update frequencies in a transfer determination table which is a copy of the update table, re-transferring data in a unit area having an update frequency equal to or lower than a first threshold, and then re-transferring data in a unit area having an update frequency equal to or lower than a second threshold higher than the first threshold.

11. A cloud computing system, comprising:
a plurality of physical servers, in each of which a virtual machine is generated; and
a migration processing unit configured to execute a migration process for moving a source virtual machine constructed on a source physical server to a destination physical server,
wherein the migration processing unit has:
a memory data transfer unit configured to transfer memory data stored in a memory of the source virtual machine from a memory of the source physical server to a memory of the destination physical server;
an update frequency measuring unit configured to measure, with respect to each unit area of the memory, an update frequency at which data in the memory of the source physical server are updated by the source virtual machine;
a memory data re-transfer unit configured to re-transfer, from the memory of the source physical server to the memory of the destination physical server, the memory data that are updated by the source virtual machine during transferring the memory data such that data in a unit area with a first update frequency are preferentially re-transferred over data in a unit area with a second update frequency higher than the first update frequency; and
a resuming unit configured to suspend the source virtual machine and then resume a destination virtual machine on the destination physical server.

12. The cloud computing system according to claim 11, wherein
the update frequency measuring unit records a data update frequency in an update table for each unit area of the memory, and
the memory data re-transfer unit refers to the update frequencies in a transfer determination table which is a copy of the update table, re-transfers data in a unit area having an update frequency equal to or lower than a first threshold, and then re-transfers data in a unit area having an update frequency equal to or lower than a second threshold higher than the first threshold.
